(19) United States
(12) Patent Application Publication
(10) Pub. No.: US 2022/0124034 A1
(43) Pub. Date: Apr. 21, 2022

(54) Congestion Measurement Method And Network Node

(71) Applicant: HUAWEI TECHNOLOGIES CO., LTD., Shenzhen (CN)

(72) Inventors: Xiaogang LU, Beijing (CN); Hongliang GAO, Beijing (CN); Liang CHENG, Beijing (CN); Juanna DANG, Beijing (CN); Dongfeng LI, Beijing (CN)

(21) Appl. No.: 17/565,711

(22) Filed: Dec. 30, 2021

Related U.S. Application Data
(63) Continuation of application No. PCT/CN2020/097315, filed on Jun. 22, 2020.

(30) Foreign Application Priority Data
Jul. 1, 2019 (CN) 201910586703.X

(51) Int. Cl. H04L 47/11; H04L 43/0876

(52) U.S. Cl. CPC H04L 47/115; H04L 43/0876

(57) ABSTRACT

The present disclosure provides example congestion measurement method and network node. One example method includes receiving a first delimitation packet by a first network node, where the first delimitation packet includes a first identifier indicating a time at which a second network node sends the first delimitation packet. Statistics associated with a congestion status of the first network node is collected based on the first delimitation packet and by using a first time interval as a length of a cycle, where the second network node sends two neighboring delimitation packets during the first time interval. A first-type statistics packet is sent to the second network node by using the first time interval as the length of the cycle, where the first-type statistics packet includes the first identifier, and the first-type statistics packet indicates the congestion status of the first network node in the first time interval.

### CROSS-REFERENCE TO RELATED APPLICATIONS

This application is a continuation of International Application No. PCT/CN2020/097315, filed on Jun. 22, 2020, which claims priority to Chinese Patent Application No. 201910586703.X, filed on Jul. 1, 2019. The disclosures of the aforementioned applications are hereby incorporated by reference in their entireties.

### TECHNICAL FIELD

This application relates to the communication field, and more specifically, to a congestion measurement method and a network node.

### BACKGROUND

With development of the Internet, users have higher requirements on network quality. Network providers need tools and methods for measuring networks to monitor the networks and control network quality to meet user needs. Currently, network adjustment is performed on a data plane, to provide network repair requirements, but a congestion status of a network path needs to be sensed at a millisecond level, so as to adjust traffic to reduce packet loss.

### SUMMARY

This application provides a congestion measurement method and a network node, to improve congestion measurement accuracy, so as to meet adjustment requirements on a data plane.

According to a first aspect, a congestion measurement method is provided. The method is performed in a communication system including a first network node and a second network node, is applied to the first network node, and includes: receiving a first delimitation packet, where the first delimitation packet includes a first identifier, and the first identifier is used to indicate a moment at which the second network node sends the first delimitation packet; collecting, based on the first delimitation packet, statistics about a congestion status of the first network node by using a first time interval as a periodicity, where the first time interval is a time interval at which the second network node sends two neighboring delimitation packets; and sending a first-type statistics packet to the second network node by using the first time interval as a periodicity, where the first-type statistics packet includes the first identifier, and the first-type statistics packet is used to indicate the congestion status of the first network node in the first time interval.

The first network node collects statistics about the congestion status of the first network node at an equal time interval based on the first delimitation packet, and sends a congestion statistics status to the second network node at an equal time interval, thereby improving congestion measurement accuracy and meeting adjustment requirements for the congestion status on a data plane.

With reference to the first aspect, in a possible implementation, the first-type statistics packet includes a first receiving rate of the first network node in the first time interval.

With reference to the first aspect, in a possible implementation, the first-type statistics packet includes a third identifier, a fourth identifier, and a quantity of data packets that are received by the first network node, where statistics about the quantity of data packets are collected by the first network node, the third identifier is used to indicate a moment at which the first network node receives the first delimitation packet, and the fourth identifier is used to indicate a moment at which the first network node sends the first-type statistics packet.

The first identifier includes a second moment, so that the first network node can obtain a correspondence between the statistics packet sent by the first network node and data about which the first network node collects statistics, thereby improving congestion measurement accuracy.

With reference to the first aspect, in a possible implementation, the method further includes: receiving a second delimitation packet at a third moment, where the second delimitation packet includes a second identifier, and the second identifier is used to indicate a moment at which the second network node sends the second delimitation packet; the second delimitation packet and the first delimitation packet are two neighboring delimitation packets; and a time interval between the third moment and a first moment is greater than the first time interval, and the first moment is a moment at which the first network node receives the first delimitation packet; and finishing collecting statistics about the congestion status of the first network node based on the second delimitation packet.

With reference to the first aspect, in a possible implementation, when the third moment and a start moment or an end moment of the first time interval do not overlap, after the finishing collecting statistics about the congestion status of the first network node based on the second delimitation packet, the method further includes: sending a second-type statistics packet to the second network node at the third moment, where the second-type statistics packet includes the first identifier, and the second-type statistics packet is used to indicate a congestion status of the first network node in a time interval between the third moment and the start moment of the first time interval in which the third moment is located.

When the third moment and the start moment or the end moment of the first time interval do not overlap, the first network node sends the second-type statistics packet to the second network node at the third moment. The second-type statistics packet is used to indicate the congestion status of the first network node in the time interval between the third moment and the start moment of the first time interval in which the third moment is located, so that the second network node obtains the congestion status of the first network node.

With reference to the first aspect, in a possible implementation, the second-type statistics packet includes a second receiving rate of the first network node in the time interval between the third moment and the start moment of the first time interval in which the third moment is located.

With reference to the first aspect, in a possible implementation, the second-type statistics packet includes a fifth identifier, a sixth identifier, and the quantity of data packets that are received by the first network node, where statistics about the quantity of data packets are collected by the first network node, the fifth identifier is used to indicate the start moment of the first time interval in which the third moment is located, and the sixth identifier is used to indicate the third moment.

With reference to the first aspect, in a possible implementation, when the third moment and the start moment or the end moment of the first time interval do not overlap, the method further includes: collecting statistics about a congestion status in a time interval between the third moment and the end moment of the first time interval in which the third moment is located; and sending a third-type statistics packet to the second network node at the end moment of the first time interval in which the third moment is located, where the third-type statistics packet is used to indicate the congestion status of the first network node in the time interval between the third moment and the end moment of the first time interval in which the third moment is located, and the third-type statistics packet includes the second identifier.

When the third moment and the start moment or the end moment of the first time interval do not overlap, the first network node collects statistics about the congestion status in the time interval between the third moment and the end moment of the first time interval in which the third moment is located, and sends the third-type statistics packet to the second network node at the end moment of the first time interval in which the third moment is located, so that the congestion status of the first network node in the time interval between the third moment and the end moment of the first time interval in which the third moment is located is sent to the second network node in time, so that the second network node obtains the corresponding congestion status, thereby improving congestion measurement accuracy.

With reference to the first aspect, in a possible implementation, the third-type statistics packet includes a third receiving rate of the first network node in the time interval between the third moment and the end moment of the first time interval in which the third moment is located.

With reference to the first aspect, in a possible implementation, the third-type statistics packet includes the sixth identifier, a seventh identifier, and the quantity of data packets that are received by the first network node, where statistics about the quantity of data packets are collected by the first network node, and the seventh identifier is used to indicate the end moment of the first time interval in which the third moment is located.

With reference to the first aspect, in a possible implementation, the method further includes: setting, as the first time interval, a time interval at which the first network node collects statistics about the congestion status.

The time interval at which the first network node collects statistics about the congestion status is set as the first time interval, thereby ensuring that the first network node reports the statistics packet at an equal time interval, so as to meet adjustment requirements on a data plane.

With reference to the first aspect, in a possible implementation, the setting, as the first time interval, a time interval at which the first network node collects statistics about the congestion status includes: receiving a setting packet, where the setting packet is used to indicate the time interval at which the first network node collects statistics about the congestion status, and the setting packet includes the first time interval; and setting, as the first time interval based on the setting packet, the time interval at which the first network node collects statistics about the congestion status.

The first network node sets, as the first time interval by using the received setting packet, the time interval at which the first network node collects statistics about the congestion status, to flexibly implement uniform time intervals at which the first network node collects statistics about the congestion status.

With reference to the first aspect, in a possible implementation, the setting, as the first time interval, a time interval at which the first network node collects statistics about the congestion status includes: setting, as the first time interval based on a communication protocol, the time interval at which the first network node collects statistics about the congestion status.

The first network node sets, as the first time interval according to stipulations in the communication protocol, the time interval at which the first network node collects statistics about the congestion status, thereby reducing signaling overheads.

With reference to the first aspect, in a possible implementation, the method further includes: sending an acknowledgment packet, where the acknowledgment packet is used to indicate that the first network node has set the time interval at which the first network node collects statistics about the congestion status.

The first network node indicates, by sending the acknowledgment packet, that the first network node has set the time interval at which the first network node collects statistics about the congestion status, thereby facilitating subsequent statistical operations.

According to a second aspect, a congestion measurement method is provided. The method is performed in a communication system including a first network node and a second network node, is applied to the second network node, and includes: sending a first delimitation packet, where the first delimitation packet includes a first identifier, and the first identifier is used to indicate a moment at which the second network node sends the first delimitation packet; sending a second delimitation packet, where the second delimitation packet includes a second identifier, the second identifier is used to indicate a moment at which the second network node sends the second delimitation packet, the second delimitation packet and the first delimitation packet are two neighboring delimitation packets, and a time interval at which the second network node sends the two neighboring delimitation packets is a first time interval; collecting statistics about first data based on the first delimitation packet and the second delimitation packet, where the first data is used to indicate a congestion status in the first time interval; receiving, by using the first time interval as a periodicity, a first-type statistics packet sent by the first network node, where the first-type statistics packet includes the first identifier, and the first-type statistics packet is used to indicate the congestion status of the first network node in the first time interval; and obtaining a first congestion degree based on the first data and the first-type statistics packet, where the first congestion degree is used to indicate a congestion degree in the first time interval.

The second network node determines a congestion status of a path between the first network node and the second network node by collecting statistics about a congestion status of the second network node in a first time interval between moments at which two neighboring delimitation packets are sent and a congestion status of the first network node in a first time interval between moments at which the first network node receives the two neighboring delimitation packets, thereby improving congestion measurement accuracy and meeting adjustment requirements for the congestion status on a data plane.

With reference to the second aspect, in a possible implementation, the first-type statistics packet includes a first receiving rate of the first network node in the first time interval.

With reference to the second aspect, in a possible implementation, the first-type statistics packet includes a third identifier, a fourth identifier, and a quantity of data packets that are received by the first network node, where statistics about the quantity of data packets are collected by the first network node, the third identifier is used to indicate a moment at which the first network node receives the first delimitation packet, and the fourth identifier is used to indicate a moment at which the first network node sends the first-type statistics packet.

With reference to the second aspect, in a possible implementation, the first identifier includes a second moment, and the second moment is a moment at which the second network node sends the first delimitation packet.

With reference to the second aspect, in a possible implementation, the second identifier includes a fourth moment, and the fourth moment is a moment at which the second network node sends the second delimitation packet.

With reference to the second aspect, in a possible implementation, the first data is a first sending rate of the second network node in the first time interval between the second moment and the fourth moment; or the first data is a quantity of data packets that are sent by the second network node in the first time interval between the second moment and the fourth moment.

With reference to the second aspect, in a possible implementation, the method further includes: receiving a second-type statistics packet, where the second-type statistics packet includes the first identifier, the second-type statistics packet is used to indicate a congestion status of the first network node in a time interval between a third moment and a start moment of the first time interval in which the third moment is located, and the third moment is a moment at which the first network node receives the second delimitation packet; and obtaining a second congestion degree based on the first data and the second-type statistics packet, where the second congestion degree is used to indicate a congestion degree in the time interval between the third moment and the start moment of the first time interval in which the third moment is located.

With reference to the second aspect, in a possible implementation, the second-type statistics packet includes a second receiving rate of the first network node in the time interval between the third moment and the start moment of the first time interval in which the third moment is located.

With reference to the second aspect, in a possible implementation, the second-type statistics packet includes a fifth identifier, a sixth identifier, and the quantity of data packets that are received by the first network node, where statistics about the quantity of data packets are collected by the first network node, the fifth identifier is used to indicate the start moment of the first time interval in which the third moment is located, the sixth identifier is used to indicate the third moment, and the third moment is the moment at which the first network node receives the second delimitation packet.

With reference to the second aspect, in a possible implementation, the method further includes: receiving a third-type statistics packet, where the third-type statistics packet includes the second identifier, and the third-type statistics packet is used to indicate a congestion status of the first network node in a time interval between the third moment and an end moment of the first time interval in which the third moment is located; collecting statistics about second data, where the second data is used to indicate a congestion status in the first time interval between a fourth moment and a fifth moment, the fourth moment is a moment at which the second network node sends the second delimitation packet, a time interval between the fifth moment and the fourth moment is the first time interval, and the fifth moment is later than the fourth moment; obtaining a third congestion degree based on the second data and the third-type statistics packet, where the third congestion degree is used to indicate a congestion degree in the time interval between the third moment and the end moment of the first time interval in which the third moment is located; and obtaining a fourth congestion degree based on the second congestion degree and the third congestion degree, where the fourth congestion degree is used to indicate a congestion degree in the first time interval in which the third moment is located.

First, the second network node receives the third-type statistics packet that is sent by the first network node at the end moment of the first time interval in which the third moment is located, and collects statistics about the second data, where the second data is the congestion status of the second network node in the time interval between the fourth moment and the fifth moment; second, the congestion degree in the time interval between the third moment and the end moment of the first time interval in which the third moment is located is determined based on the second data and the third-type statistics packet; and finally, the congestion degree in the first time interval in which the third moment is located is obtained based on the congestion degree in the time interval between the third moment and the start moment of the first time interval in which the third moment is located and the congestion degree in the time interval between the third moment and the end moment of the first time interval in which the third moment is located, thereby improving congestion measurement accuracy.

With reference to the second aspect, in a possible implementation, that the second network node obtains the fourth congestion degree based on the second congestion degree and the third congestion degree includes: The second network node determines an average value of the second congestion degree and the third congestion degree as the fourth congestion degree.

With reference to the second aspect, in a possible implementation, the second data is a second sending rate in the time interval between the fourth moment and the fifth moment; or the second data is a quantity of data packets that are sent by the second network node in the time interval between the fourth moment and the fifth moment.

With reference to the second aspect, in a possible implementation, the third-type statistics packet includes a third receiving rate of the first network node in the time interval between the third moment and the end moment of the first time interval in which the third moment is located.

With reference to the second aspect, in a possible implementation, the third-type statistics packet includes the sixth identifier, a seventh identifier, and the quantity of data packets that are received by the first network node, where statistics about the quantity of data packets are collected by the first network node, and the seventh identifier is used to indicate the end moment of the first time interval in which the third moment is located.

With reference to the second aspect, in a possible implementation, the method further includes: sending a setting packet, where the setting packet is used to indicate a time interval at which the first network node collects statistics about the congestion status, and the setting packet includes the first time interval.

With reference to the second aspect, in a possible implementation, the method further includes: receiving an acknowledgment packet, where the acknowledgment packet is used to indicate that the first network node has set the time interval at which the first network node collects statistics about the congestion status.

According to a third aspect, a network node is provided. The network node includes a first network node and a second network node, the network node is the first network node, and the network node includes: a receiving module, configured to receive a first delimitation packet, where the first delimitation packet includes a first identifier, and the first identifier is used to indicate a moment at which the second network node sends the first delimitation packet; a processing module, configured to collect, based on the first delimitation packet, statistics about a congestion status of the network node by using a first time interval as a periodicity, where the first time interval is a time interval at which the second network node sends two neighboring delimitation packets; and a sending module, configured to send a first-type statistics packet to the second network node by using the first time interval as a periodicity, where the first-type statistics packet includes the first identifier, and the first-type statistics packet is used to indicate a congestion status of the network node in the first time interval.

With reference to the third aspect, in a possible implementation, the first-type statistics packet includes a first receiving rate of the network node in the first time interval.

With reference to the third aspect, in a possible implementation, the first-type statistics packet includes a third identifier, a fourth identifier, and a quantity of data packets that are received by the network node, where statistics about the quantity of data packets are collected by the network node, the third identifier is used to indicate a moment at which the network node receives the first delimitation packet, and the fourth identifier is used to indicate a moment at which the network node sends the first-type statistics packet.

With reference to the third aspect, in a possible implementation, the first identifier includes a second moment.

With reference to the third aspect, in a possible implementation, the receiving module is further configured to: receive a second delimitation packet at a third moment, where the second delimitation packet includes a second identifier, and the second identifier is used to indicate a moment at which the second network node sends the second delimitation packet; the second delimitation packet and the first delimitation packet are two neighboring delimitation packets; a time interval between the third moment and a first moment is greater than the first time interval, and the first moment is a moment at which the network node receives the first delimitation packet; and the processing module is further configured to: finish collecting statistics about the congestion status of the network node based on the second delimitation packet.

With reference to the third aspect, in a possible implementation, the second identifier includes a fourth moment.

With reference to the third aspect, in a possible implementation, when the third moment and a start moment or an end moment of the first time interval do not overlap, the sending module is further configured to: send a second-type statistics packet to the second network node at the third moment, where the second-type statistics packet includes the first identifier, and the second-type statistics packet is used to indicate a congestion status of the network node in a time interval between the third moment and the start moment of the first time interval in which the third moment is located.

With reference to the third aspect, in a possible implementation, the second-type statistics packet includes a second receiving rate of the network node in the time interval between the third moment and the start moment of the first time interval in which the third moment is located.

With reference to the third aspect, in a possible implementation, the second-type statistics packet includes a fifth identifier, a sixth identifier, and the quantity of data packets that are received by the network node, where statistics about the quantity of data packets are collected by the network node, the fifth identifier is used to indicate the start moment of the first time interval in which the third moment is located, and the sixth identifier is used to indicate the third moment.

With reference to the third aspect, in a possible implementation, when the third moment and the start moment or the end moment of the first time interval do not overlap, the processing module is further configured to: collect statistics about a congestion status in a time interval between the third moment and the end moment of the first time interval in which the third moment is located; and the sending module is further configured to: send a third-type statistics packet to the second network node at the end moment of the first time interval in which the third moment is located, where the third-type statistics packet includes the second identifier, and the third-type statistics packet is used to indicate the congestion status of the network node in the time interval between the third moment and the end moment of the first time interval in which the third moment is located.

With reference to the third aspect, in a possible implementation, the third-type statistics packet includes a third receiving rate of the network node in the time interval between the third moment and the end moment of the first time interval in which the third moment is located.

With reference to the third aspect, in a possible implementation, the third-type statistics packet includes the sixth identifier, a seventh identifier, and the quantity of data packets that are received by the network node, where statistics about the quantity of data packets are collected by the network node, and the seventh identifier is used to indicate the end moment of the first time interval in which the third moment is located.

With reference to the third aspect, in a possible implementation, the processing module is further configured to: set, as the first time interval, a time interval at which the network node collects statistics about the congestion status.

With reference to the third aspect, in a possible implementation, the receiving module is further configured to: receive a setting packet, where the setting packet is used to indicate a time interval at which the network node collects statistics about the congestion status, and the setting packet includes the first time interval; and the processing module is further configured to: set, as the first time interval based on the setting packet, the time interval at which the network node collects statistics about the congestion status.

With reference to the third aspect, in a possible implementation, the processing module is further configured to: set, as the first time interval based on a communication protocol, the time interval at which the network node collects statistics about the congestion status.

With reference to the third aspect, in a possible implementation, the sending module is further configured to: send an acknowledgment packet, where the acknowledgment packet is used to indicate that the network node has set the time interval at which the network node collects statistics about the congestion status.

According to a fourth aspect, a network node is provided. The network node

includes a first network node and a second network node, the network node is the second network node, and the network node includes: a sending module, configured to send a first delimitation packet at a second moment, where the first delimitation packet includes a first identifier, and the first identifier is used to indicate the moment at which the network node sends the first delimitation packet, where the sending module is further configured to send a second delimitation packet at a fourth moment, the second delimitation packet includes a second identifier, the second identifier is used to indicate a moment at which the network node sends the second delimitation packet, the second delimitation packet and the first delimitation packet are two neighboring delimitation packets, and a time interval between the fourth moment and the second moment is equal to a first time interval; a processing module, configured to collect statistics about first data based on the first delimitation packet and the second delimitation packet, where the first data is used to indicate a congestion status in the first time interval between the second moment and the fourth moment; and a receiving module, configured to receive, by using the first time interval as a periodicity, a first-type statistics packet sent by the first network node, where the first-type statistics packet includes the first identifier, and the first-type statistics packet is used to indicate a congestion status of the first network node in the first time interval, where the processing module is further configured to obtain a first congestion degree based on the first data and the first-type statistics packet, and the first congestion degree is used to indicate a congestion degree in the first time interval.

With reference to the fourth aspect, in a possible implementation, the first-type statistics packet includes a first receiving rate of the first network node in the first time interval.

With reference to the fourth aspect, in a possible implementation, the first-type statistics packet includes a third identifier, a fourth identifier, and a quantity of data packets that are received by the first network node, where statistics about the quantity of data packets are collected by the first network node, the third identifier is used to indicate a moment at which the first network node receives the first delimitation packet, and the fourth identifier is used to indicate a moment at which the first network node sends the first-type statistics packet.

With reference to the fourth aspect, in a possible implementation, the first identifier includes a second moment, and the second moment is a moment at which the second network node sends the first delimitation packet.

With reference to the fourth aspect, in a possible implementation, the second identifier includes a fourth moment, and the fourth moment is a moment at which the second network node sends the second delimitation packet.

With reference to the fourth aspect, in a possible implementation, the first data is a first sending rate of the network node in the first time interval between the second moment and the fourth moment; or the first data is a quantity of data packets that are sent by the network node in the first time interval between the second moment and the fourth moment.

With reference to the fourth aspect, in a possible implementation, the receiving module is further configured to: receive a second-type statistics packet, where the second-type statistics packet includes the first identifier, the second-type statistics packet is used to indicate a congestion status of the first network node in a time interval between a third moment and a start moment of the first time interval in which the third moment is located, and the third moment is a moment at which the first network node receives the second delimitation packet; and the processing module is further configured to: obtain a second congestion degree based on the first data and the second-type statistics packet, where the second congestion degree is used to indicate a congestion degree in the time interval between the third moment and the start moment of the first time interval in which the third moment is located.

With reference to the fourth aspect, in a possible implementation, the second-type statistics packet includes a second receiving rate of the first network node in the time interval between the third moment and the start moment of the first time interval in which the third moment is located.

With reference to the fourth aspect, in a possible implementation, the second-type statistics packet includes a fifth identifier, a sixth identifier, and the quantity of data packets that are received by the first network node, where statistics about the quantity of data packets are collected by the first network node, the fifth identifier is used to indicate the start moment of the first time interval in which the third moment is located, and the sixth identifier is used to indicate the third moment.

With reference to the fourth aspect, in a possible implementation, the receiving module is further configured to: receive a third-type statistics packet, where the third-type statistics packet includes the second identifier, and the third-type statistics packet is used to indicate a congestion status of the first network node in a time interval between the third moment and an end moment of the first time interval in which the third moment is located; and the processing module is further configured to: collect statistics about second data, where the second data is used to indicate a congestion status in the first time interval between a fourth moment and a fifth moment, a time interval between the fifth moment and the fourth moment is the first time interval, and the fifth moment is later than the fourth moment; obtain a third congestion degree based on the second data and the third-type statistics packet, where the third congestion degree is used to indicate a congestion degree in the time interval between the third moment and the end moment of the first time interval in which the third moment is located; and obtain a fourth congestion degree based on the second congestion degree and the third congestion degree, where the fourth congestion degree is used to indicate a congestion degree in the first time interval in which the third moment is located.

With reference to the fourth aspect, in a possible implementation, the processing module is further configured to: determine an average value of the second congestion degree and the third congestion degree as the fourth congestion degree.

With reference to the fourth aspect, in a possible implementation, the second data is a second sending rate in the time interval between the fourth moment and the fifth moment; or the second data is a quantity of data packets that are sent by the network node in the time interval between the fourth moment and the fifth moment.

With reference to the fourth aspect, in a possible implementation, the third-type statistics packet includes a third receiving rate of the first network node in the time interval between the third moment and the end moment of the first time interval in which the third moment is located.

With reference to the fourth aspect, in a possible implementation, the third-type statistics packet includes the sixth identifier, a seventh identifier, and the quantity of data packets that are received by the first network node, where statistics about the quantity of data packets are collected by the first network node, and the seventh identifier is used to indicate the end moment of the first time interval in which the third moment is located.

With reference to the fourth aspect, in a possible implementation, the sending module is further configured to: send a setting packet, where the setting packet is used to indicate a time interval at which the first network node collects statistics about the congestion status, and the setting packet includes the first time interval.

With reference to the fourth aspect, in a possible implementation, the receiving module is further configured to: receive an acknowledgment packet, where the acknowledgment packet is used to indicate that the first network node has set the time interval at which the first network node collects statistics about the congestion status.

According to a fifth aspect, a network node is provided. The network node includes a transceiver, a processor, and a memory. The processor is configured to control the transceiver to receive and send a signal. The memory is configured to store a computer program. The processor is configured to invoke the computer program from the memory and run the computer program, so that the network node performs the method in any one of the first aspect or the possible implementations of the first aspect.

In a design, the network node is a communication chip, the receiving module may be an input circuit or an interface of the communication chip, and the sending module may be an output circuit or an interface of the communication chip.

According to a sixth aspect, a network node is provided. The network node includes a transceiver, a processor, and a memory. The processor is configured to control the transceiver to receive and send a signal. The memory is configured to store a computer program. The processor is configured to invoke the computer program from the memory and run the computer program, so that the network node performs the method in any one of the second aspect or the possible implementations of the second aspect.

In a design, the network node is a communication chip, the receiving module may be an input circuit or an interface of the communication chip, and the sending module may be an output circuit or an interface of the communication chip.

According to a seventh aspect, a network system is provided. The network system includes the network node according to any one of the third aspect or the possible implementations of the third aspect and the network node according to any one of the fourth aspect or the possible implementations of the fourth aspect.

According to an eighth aspect, a computer program product including instructions is provided. When the computer program product runs on a computer, the computer is enabled to perform the methods according to the foregoing aspects.

According to a ninth aspect, a computer-readable storage medium is provided. The computer-readable storage medium stores instructions. When the instructions are run on a computer, the computer is enabled to perform the method according to the foregoing aspects.

### BRIEF DESCRIPTION OF DRAWINGS

FIG. 1 is a schematic diagram of forwarding an SRv6 packet;

FIG. 2 is a schematic diagram of a moment at which two network nodes send a packet on a single path;

FIG. 3 is a schematic flowchart of a congestion measurement method 300 according to an embodiment of this application;

FIG. 4 shows a form of a setting packet according to an embodiment of this application;

FIG. 5 shows a form of an acknowledgment packet according to an embodiment of this application;

FIG. 6 shows a form of a statistics packet according to an embodiment of this application;

FIG. 7 is a schematic diagram of moments at which a network node sends a delimitation packet and generates a statistics packet according to an embodiment of this application;

FIG. 8 is a schematic diagram of moments at which another network node sends a delimitation packet and generates a statistics packet according to an embodiment of this application;

FIG. 9 is a schematic block diagram of a network node according to an embodiment of this application;

FIG. 10 is another schematic block diagram of a network node according to an embodiment of this application;

FIG. 11 is a schematic block diagram of a network node according to an embodiment of this application;

FIG. 12 is another schematic block diagram of a network node according to an embodiment of this application; and

FIG. 13 is a schematic block diagram of a network system according to an embodiment of this application.

### DESCRIPTION OF EMBODIMENTS

For ease of understanding of embodiments of this application, the following descriptions are first provided before the embodiments of this application are described.

First, in the embodiments of this application, an “indication” may include a direct indication and an indirect indication, or may include an explicit indication and an implicit indication. Information indicated by a piece of information (for example, first indication information described below) is referred to as to-be-indicated information. In a specific implementation process, the to-be-indicated information may be indicated in a plurality of manners, for example, but not limited to, a manner of directly indicating the to-be-indicated information. For example, the to-be-indicated information is indicated by using the to-be-indicated information or an index of the to-be-indicated information. Alternatively, the to-be-indicated information may be indirectly indicated by indicating other information, and there is an association relationship between the other information and the to-be-indicated information. Alternatively, only a part of the to-be-indicated information may be indicated, and the other part of the to-be-indicated information is already known or pre-agreed on. For example, specific information may alternatively be indicated by using an arrangement sequence of a plurality of pieces of information that is pre-agreed on (for example, stipulated in a protocol), to reduce indication overheads to some extent.

Second, the terms “first”, “second”, and various numbers in the following embodiments are merely used for differentiation for ease of description, and are not used to limit the scope of the embodiments of this application. For example, the terms are used to distinguish between different packets.

Third, “protocol” in the embodiments of this application may be a standard protocol in the communication field, for example, including an LTE protocol, a New Radio (NR) protocol, and a related protocol applied to a future communication system. This is not limited in this application.

Fourth, “a plurality of” in the embodiments of this application means two or more. “One or more of the following items (pieces)” or a similar expression thereof refers to any combination of these items, including any combination of singular items (pieces) or plural items (pieces). For example, “at least one or more of a, b, and c” may indicate a, b, c, a and b, a and c, b and c, or a, b, and c, where a, b, and c may be singular or plural.

Fifth, the “timestamp” in the embodiments of this application is at least accurate to milliseconds. In other words, the “timestamp” may be ×year×month×day×hour×minute×second×millisecond, for example, 2019-05-27 08:10:5:1. Alternatively, the “timestamp” may be ×year×month×day×hour×minute×second×millisecond×microsecond, for example, 2019-05-28 13:10:8:5:10.

Sixth, the “moment” in the embodiments of this application is at least accurate to milliseconds. In other words, the “moment” may be ×year×month×day×hour×minute×second×millisecond, for example, 2019-05-29 06:50:22:1. Alternatively, the “moment” may be ×year×month×day×hour×minute×second×millisecond×microsecond, for example, 2019-05-30 13:46:9:5:10.

The following describes technical solutions in this application with reference to the accompanying drawings.

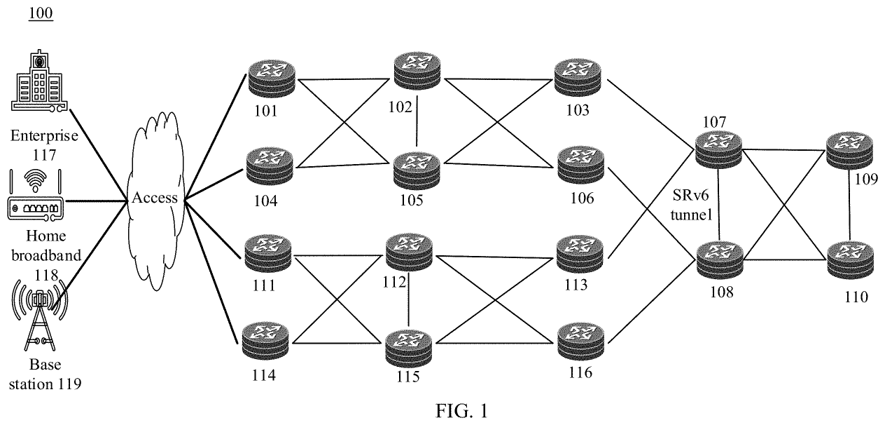

FIG. 1 is a schematic diagram of forwarding a Segment Routing Internet Protocol Version 6 (SRv6) packet. A network 100 shown in FIG. 1 includes nodes 101 to 116, an enterprise 117, a home broadband 118, and a base station 119. The node may be a router device. The enterprise 117, the home broadband 118, and the base station 119 are separately connected to corresponding nodes, to implement packet forwarding.

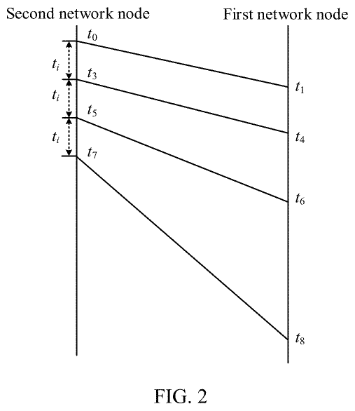

FIG. 2 is a schematic diagram of a moment at which two network nodes send a packet on a single path. A second network node may be a source (which may be understood as a transmit end), and a first network node may be a sink (which may be understood as a receive end). The second network node continuously sends measurement packets to the first network node at an equal time interval tᵢ. For example, the second network node sends four measurement packets. The second network node sends a first measurement packet at a moment t₀, and the first network node receives the first measurement packet at a moment t₁. The second network node sends a second measurement packet at a moment t₃, and the first network node receives the second measurement packet at a moment t₄. The second network node sends a third measurement packet at a moment t₅, and the first network node receives the third measurement packet at a moment t₆. The second network node sends a fourth measurement packet at a moment t₇, and the first network node receives the fourth measurement packet at a moment t₈. A time interval between t₀ and t₃ is tᵢ, a time interval between t₃ and t₅ is tᵢ, and a time interval between t₅ and t₇ is tᵢ. The first network node generates a first statistics packet corresponding to the first measurement packet in a time interval between t₁ and t₄. The first network node generates a second statistics packet corresponding to the second measurement packet in a time interval between t₄ and t₆. The first network node generates a third statistics packet corresponding to the third measurement packet in a time interval between t₆ and t₈. Because congestion statuses of paths continuously change, the time interval between t₁ and t₄, the time interval between t₄ and t₆, and the time interval between t₆ and t₈ may not be equal. Therefore, congestion measurement cannot be performed in real time, and adjustment requirements on a data plane cannot be met.

Therefore, it is urgent to provide a method that can meet adjustment requirements on a data plane.

The following describes in detail the method provided in the embodiments of this application with reference to the accompanying drawings.

In the following shown embodiments, optionally, the first network node and the second network node may be router devices.

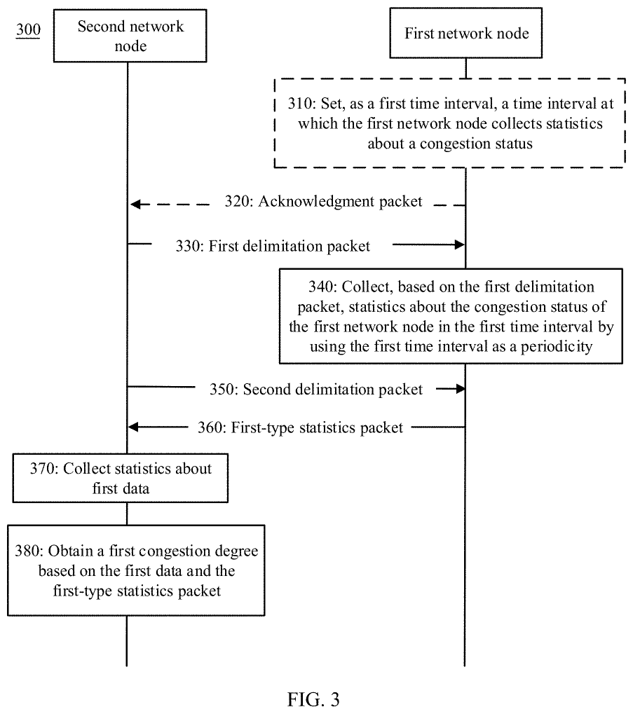

In the following, the embodiments of this application are described in detail by using an example of interaction between the first network node and the second network node. FIG. 3 is a schematic flowchart of a congestion measurement method 300 according to an embodiment of this application from a perspective of interaction between the first network node and the second network node. As shown in FIG. 3, the method 300 may include step 310 to step 380. The following describes the steps in the method 300 in detail.

The method is performed in a communication system including the first network node and the second network node. The method may be used in congestion measurement of one path between the first network node and the second network node. The path may be understood as any of a plurality of paths configured for one tunnel between the first network node and the second network node.

Step 310: The first network node sets, as a first time interval, a time interval at which the first network node collects statistics about a congestion status.

The first time interval is a time interval at which the second network node sends two neighboring delimitation packets.

In network measurement, a data packet is used as an observation sample, and two measurement packets are inserted into data traffic to bound a scope of the observation sample. The two measurement packets are delimitation packets. The delimitation packets are used to indicate that a time period in which the second network node collects statistics about the congestion status corresponds to a time period in which the first network node collects statistics about the congestion status.

For example, as shown in FIG. 2, the second network node sends a 1^{st} delimitation packet at a moment t₀, and the second network node sends a 2^{nd} delimitation packet at a moment t₇. The first network node receives the 1^{st} delimitation packet at a moment t₁, and the first network node receives the 2^{nd} delimitation packet at a moment t₈. A data packet used by the second network node as an observation sample is a data packet sent by the second network node in a time interval between the moment t₀ and the moment t₇. Correspondingly, a data packet that is used by the first network node as an observation sample and that corresponds to the data packet used by the second network node as an observation sample is a data packet received by the first network node in a time interval between the moment t₁ and the moment t₈.

The delimitation packet may be understood as a protocol packet. The delimitation packet may also be understood as a packet formed after a data packet is colored and is different from the data packet. When receiving a packet, the first network node may determine, by using a packet type indicated in a field in the packet, whether the received packet is a delimitation packet, a data packet, or a packet of another type.

The first network node may set, in the following two manners, the time interval at which the first network node collects statistics about the congestion status.

Manner 1

The first network node receives a setting packet sent by the second network node. The setting packet is used to indicate the time interval at which the first network node collects statistics about the congestion status, and the setting packet includes the first time interval.

That the setting packet includes the first time interval may be understood as that the time interval that is indicated in the setting packet and at which the first network node collects statistics about the congestion status is the first time interval.

The first network node sets, as the first time interval based on the setting packet, the time interval at which the first network node collects statistics about the congestion status. For example, the first time interval included in the setting packet may be 0.5 ms, and the first network node sets, as 0.5 ms based on the setting packet, the time interval at which the first network node collects statistics about the congestion status. For another example, the first time interval included in the setting packet may be 1 ms, and the first network node sets, as 1 ms based on the setting packet, the time interval at which the first network node collects statistics about the congestion status.

Optionally, that the first network node collects statistics about the congestion status at the time interval may be understood as that the first network node collects statistics about the congestion status of the first network node once every time interval. For example, when the first time interval is 0.5 ms, the first network node collects statistics about the congestion status of the first network node once every 0.5 ms. For another example, when the first time interval is 1 ms, the first network node collects statistics about the congestion status of the first network node once every 1 ms.

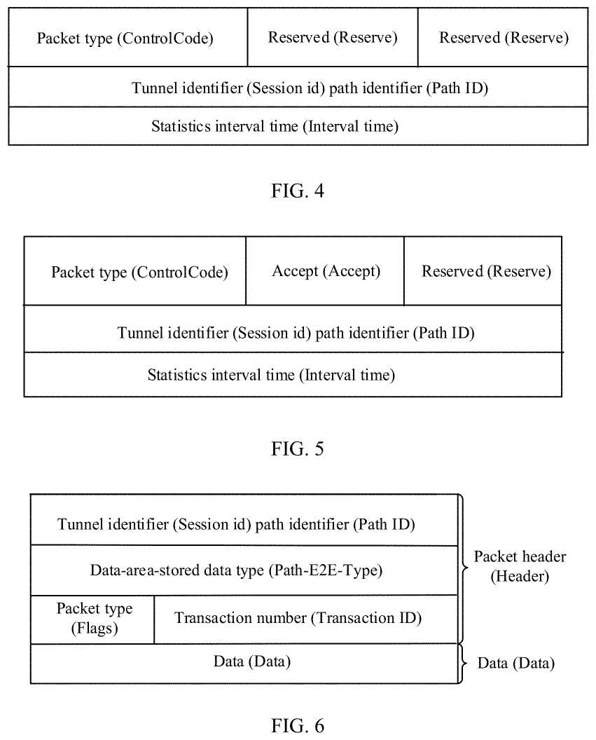

For example, a form of the setting packet may be shown in FIG. 4. The setting packet may include a packet type (Control Code) field, a tunnel identifier (Session id) path identifier (Path ID) field, and a statistics collection interval time (Interval time) field. In the packet type field, when the packet type field indicates 0, the packet is a setting packet; and when the packet type field indicates 1, the packet is an acknowledgment packet. The tunnel identifier path identifier field indicates an identifier of a tunnel path that needs to be measured. The statistics collection interval time field indicates a time interval (for example, the first time interval) at which the first network node performs statistics collection, a statistics collection interval time may occupy 16 bits, a unit of the statistics collection interval time is milliseconds (ms), and the packet type field indicates 0. The setting packet may further include two reserved (Reserve) fields.

Manner 2

The time interval at which the first network node collects statistics about the congestion status is stipulated in a communication protocol, and it is stipulated that the time interval at which the first network node collects statistics about the congestion status is the first time interval.

The first network node sets, as the first time interval according to stipulations in the communication protocol, the time interval at which the first network node collects statistics about the congestion status. For example, the first time interval stipulated in the communication protocol may be 0.6 ms, and the first network node sets, as 0.6 ms based on the first time interval stipulated in the communication protocol, the time interval at which the first network node collects statistics about the congestion status. For another example, the first time interval stipulated in the communication protocol may be 0.8 ms, and the first network node sets, as 0.8 ms based on the first time interval stipulated in the communication protocol, the time interval at which the first network node collects statistics about the congestion status.

After the first network node has set the time interval at which the first network node collects statistics about the congestion status, step 320 may be performed.

Step 320: The second network node receives an acknowledgment packet sent by the first network node, where the acknowledgment packet is used to indicate that the first network node has set the time interval at which the first network node collects statistics about the congestion status.

For example, a form of the acknowledgment packet may be shown in FIG. 5. The acknowledgment packet may include a packet type field, a tunnel identifier path identifier field, a statistics collection interval time field, and an accept field, and the acknowledgment packet may further include a reserved field. The accept field is used to indicate a setting result part in the acknowledgment packet. If the first network node succeeds in setting based on the setting packet, the accept field indicates 0. If the first network node fails in setting based on the setting packet, the accept field indicates 1, and the packet type field indicates 1.

When the accept field in the acknowledgment packet indicates 0, the second network node starts to perform a measurement operation, that is, perform step 330.

Step 330: The second network node sends a first delimitation packet, where the first delimitation packet includes a first identifier, and the first identifier is used to indicate a moment at which the second network node sends the first delimitation packet. Correspondingly, the first network node receives the first delimitation packet.

Optionally, the moment at which the second network node sends the first delimitation packet may be a second moment, and a moment at which the first network node receives the first delimitation packet is a first moment. The first moment is later than the second moment. That the first identifier is used to indicate the moment at which the second network node sends the first delimitation packet may be understood as that the first identifier is used to indicate the second moment.

Optionally, when sending the first delimitation packet, the second network node records the first identifier, includes the first identifier in the first delimitation packet, and sends the first delimitation packet to the first network node.

Optionally, the first identifier may be a first timestamp. The first timestamp is used to indicate the moment at which the second network node sends the first delimitation packet, that is, the first timestamp is used to indicate the second moment.

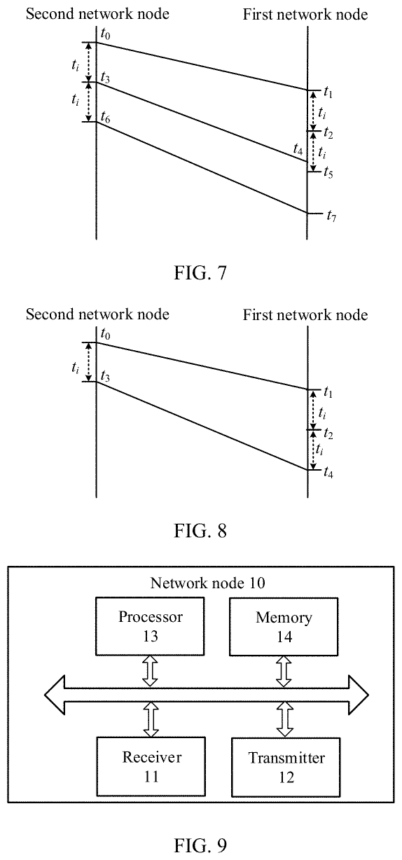

For example, as shown in FIG. 7, the second network node sends the first delimitation packet at a moment t₀, and the first network node receives the first delimitation packet at a moment t₁. Therefore, the second moment may be the moment t₀, the first moment may be the moment t₁, and the moment t₀ is earlier than the moment t₁.

Optionally, after receiving the first delimitation packet, the first network node records a third identifier. The third identifier is used to indicate the moment at which the first network node receives the first delimitation packet, that is, the first moment.

The third identifier may be a third timestamp. The third timestamp is used to indicate the moment at which the first network node receives the first delimitation packet. In other words, the third timestamp is the first moment.

Step 340: The first network node collects, based on the first delimitation packet, statistics about the congestion status of the first network node in the first time interval by using the first time interval as a periodicity, where the first time interval is a time interval at which the second network node sends two neighboring delimitation packets.

Optionally, when starting to collect statistics about the congestion status in the first time interval, the first network node records an identifier. The identifier is used to indicate a moment at which the first network node starts statistics collection. The identifier may be a timestamp.

Optionally, that the first network node collects, based on the first delimitation packet, statistics about the congestion status of the first network node in the first time interval by using the first time interval as a periodicity may be understood as that after receiving the first delimitation packet, the first network node collects statistics about the congestion status of the first network node in a corresponding first time interval once every first time interval.

For example, as shown in FIG. 7, the first network node receives the first delimitation packet at the moment t₁, and collects statistics about the congestion status in the first time interval based on the first delimitation packet. The first time interval is tᵢ, that is, the first network node collects statistics about the congestion status of the first network node once every first time interval tᵢ starting from the moment t₁.

The congestion status of the first network node in the first time interval may be understood as a receiving rate of the first network node in the first time interval. Alternatively, the congestion status of the first network node in the first time interval may be understood as a quantity of data packets that are received by the first network node in the first time interval.

Step 350: The second network node sends a second delimitation packet, where the second delimitation packet includes a second identifier, and the second identifier is used to indicate a moment at which the second network node sends the second delimitation packet; the second delimitation packet and the first delimitation packet are two neighboring delimitation packets; and a time interval at which the second network node sends the two neighboring delimitation packets is the first time interval. Correspondingly, the first network node receives the second delimitation packet at a third moment. A time interval between the third moment and the first moment is greater than the first time interval, and the first moment is the moment at which the first network node receives the first delimitation packet.

Optionally, when sending the second delimitation packet, the second network node records the second identifier, includes the second identifier in the second delimitation packet, and sends the second delimitation packet to the first network node.

Optionally, the moment at which the second network node sends the second delimitation packet may be a fourth moment.

Optionally, the second identifier may be a second timestamp. The second timestamp is used to indicate the moment at which the second network node sends the second delimitation packet, that is, the second timestamp is used to indicate the fourth moment.

That the second delimitation packet and the first delimitation packet are two neighboring delimitation packets may be understood as that the second network node respectively sends the first delimitation packet and the second delimitation packet to the first network node at moments whose difference is the first time interval, and the second network node does not send another delimitation packet in the first time interval; or that the second delimitation packet and the first delimitation packet are two neighboring delimitation packets may be understood as that the first network node respectively receives, at moments whose difference is the first time interval, the first delimitation packet and the second delimitation packet that are sent by the second network node, and the first network node does not receive another delimitation packet in the first time interval.

For example, as shown in FIG. 7, the second network node sends the first delimitation packet at the moment t₀, and the first network node receives the first delimitation packet at the moment t₁. The second network node sends the second delimitation packet at a moment t₃, and the first network node receives the second delimitation packet at a moment t₄. The fourth moment may be the moment t₃, the third moment may be the moment t₄, the moment t₃ is earlier than the moment t₄, the first time interval is tᵢ, and a time interval between the moment t₁ and the moment t₄ is greater than tᵢ.

Step 360: The first network node sends a first-type statistics packet to the second network node by using the first time interval as a periodicity, where the first-type statistics packet includes the first identifier, and the first-type statistics packet is used to indicate the congestion status of the first network node in the first time interval. Correspondingly, the second network node receives, by using the first time interval as a periodicity, the first-type statistics packet sent by the first network node.

Optionally, that the first network node sends a first-type statistics packet to the second network node by using the first time interval as a periodicity may be understood as that the first network node sends the first-type statistics packet to the second network node by using the first moment as a start moment and by using the first time interval as a periodicity. In other words, a moment at which the first network node sends the first-type statistics packet may be Tᵢ=t₁+Ntᵢ. t₁ is the moment at which the first network node receives the first delimitation packet, that is, the first moment, N is a positive integer, and tᵢ is the first time interval.

For example, a form of the statistics packet is shown in FIG. 6. The statistics packet may include two parts: a packet header and data. The packet header may include a tunnel identifier path identifier field, a data-area-stored data type (Path-E2E-Type) field, a packet type (Flags) field, and a transaction number (Transaction ID) field. The tunnel identifier path identifier field is used to indicate an identifier of a path about which the first network node collects statistics. In the data-area-stored data type field, for example, data-area-stored data may be a timestamp and/or a quantity of packets. The timestamp may be indicated by using Bit 0, and the timestamp may be understood as two moments, that is, a start moment and an end moment. The quantity of packets may be indicated by using Bit 1, and the quantity of packets may be a quantity of packets between the start moment and the end moment. The data-area-stored data type field may store a plurality of fields. In the packet type (Flags) field, when the packet type field is indicated by using Bit 0, the type of a packet is a statistics packet. When the packet type field is indicated by using Bit 1, the type of a packet is a result packet, and other fields are temporarily reserved. One transaction number is generated each time statistics are collected. The transaction number may be understood as for which time statistics are collected. In the data part, a data type indicated by the data-area-stored data type may be a timestamp and/or a quantity of packets, for example, may be the first moment, the second moment, or a quantity of packets that are received by the first network node in a time interval between the first moment and a moment at which the first network node sends a statistics packet.

Optionally, the first-type statistics packet includes a first receiving rate of the first network node in the first time interval. Alternatively, the first-type statistics packet includes the third identifier, a fourth identifier, and a quantity of data packets that are received by the first network node, where statistics about the quantity of data packets are collected by the first network node, the third identifier is used to indicate the moment at which the first network node receives the first delimitation packet, and the fourth identifier is used to indicate a moment at which the first network node sends the first-type statistics packet.

The quantity, included in the first-type statistics packet, of the data packets that are received by the first network node may be understood as a quantity of data packets that are received by the first network node in a time interval between the first moment and the moment at which the first network node sends the first-type statistics packet.

Optionally, when sending the first-type statistics packet, the first network node records the fourth identifier and includes the fourth identifier in the first-type statistics packet. The first network node also includes the first identifier in the first delimitation packet and the third identifier recorded in the first network node together in the first-type statistics packet, and sends the first-type statistics packet to the second network node.

Optionally, the fourth identifier may be a fourth timestamp. The fourth timestamp is used to indicate the moment at which the first network node sends the first-type statistics packet.

Optionally, the fourth identifier includes the moment at which the first network node sends the first-type statistics packet.

As shown in FIG. 8, the second network node sends a first delimitation packet at a moment t₀, and sends a second delimitation packet at a moment t₃. A time interval between the moment t₀ and the moment t₃ is a first time interval t₃. The first network node receives the first delimitation packet at a moment t₁, and receives the second delimitation packet at a moment t₄. A time interval between the moment t₁ and the moment t₄ is two first time intervals. For example, the first-type statistics packet may include a first receiving rate of the first network node in the time interval tᵢ between the moment t₁ and a moment t₂ ((t₁+tᵢ)); or the first-type statistics packet includes the moment t₀, the moment t₁, the moment t₂, and a quantity of data packets that are received by the first network node in a time interval (a 1^{st} tᵢ) between the moment t₁ and the moment t₂. For another example, the first-type statistics packet may further include a first receiving rate of the first network node in the time interval tᵢ between the moment t₂ and a moment t₄ ((t₂+2tᵢ)); or the first-type statistics packet includes the moment t₃, the moment t₂, the moment t₄, and a quantity of data packets that are received by the first network node in a time interval (a 2^{nd} tᵢ) between the moment t₂ and the moment t₄.

Step 370: The second network node collects statistics about first data based on the first delimitation packet and the second delimitation packet, where the first data is used to indicate a congestion status in the first time interval.

Optionally, the first data may be a first sending rate in a time interval between the second moment and the fourth moment; or the first data is a quantity of data packets that are sent by the second network node in the time interval between the second moment and the fourth moment.

As shown in FIG. 8, the second network node sends the first delimitation packet at the moment t₀, and the second network node sends the second delimitation packet at the moment t₃. In other words, the second moment is the moment t₀, and the fourth moment is the moment t₃. The first data is the congestion status of the second network node in the first time interval tᵢ between the moment t₀ and the moment t₃. The first data may be a first sending rate of the second network node in the first time interval tᵢ between the moment t₀ and the moment t₃; or the first data may be a quantity of data packets that are sent by the second network node in the first time interval tᵢ between the moment t₀ and the moment t₃.

Optionally, a time interval between the moment at which the first network node receives the first delimitation packet and the moment at which the first network node receives the second delimitation packet may be an integer multiple of the first time interval, For example, as shown in FIG. 8, the time interval between the moment at which the first network node receives the first delimitation packet and the moment at which the first network node receives the second delimitation packet is twice the first time interval. The time interval between the moment at which the first network node receives the first delimitation packet and the moment at which the first network node receives the second delimitation packet may not be an integer multiple of the first time interval, For example, as shown in FIG. 7, the time interval between the moment at which the first network node receives the first delimitation packet and the moment at which the first network node receives the second delimitation packet is 1.8 times the first time interval. This is not limited in this application.

Step 380: The second network node obtains a first congestion degree based on the first data and the first-type statistics packet, where the first congestion degree is used to indicate a congestion degree in the first time interval.

Optionally, after receiving the first-type statistics packet, the second network node may determine, based on the first identifier in the first-type statistics packet, that the first-type statistics packet sent by the first network node corresponds to the first data about which the second network node collects statistics. In other words, the second network node needs to obtain the first congestion degree based on the first data and the first-type statistics packet. The first congestion degree is used to indicate the congestion degree in the first time interval.

For example, as shown in FIG. 8, the first congestion degree may be a congestion degree of a corresponding path in the time interval between the moment t₁ and the moment t₂. For another example, as shown in FIG. 8, the first congestion degree may be a congestion degree of a corresponding path in the time interval between the moment t₂ and the moment t₄.

Optionally, the second network node may obtain a first congestion degree J₁ based on the following formula:

$${J}_{1} = \frac{\frac{a}{{t}_{i}}}{\frac{b}{{t}_{i}}}$$

where a is the quantity of data packets that are received by the first network node in the first time interval, b is the quantity of data packets that are sent by the second network node in the time interval between the second moment and the fourth moment, and tᵢ is the first time interval.

For example, as shown in FIG. 8, a may be a quantity of data packets that are received by the first network node in the time interval between the moment t₁ and the moment t₂; or a may be a quantity of data packets that are received by the first network node in the time interval between the moment t₂ and the moment t₄.

For example, as shown in FIG. 8, b may be a quantity of data packets that are sent by the second network node in the time interval between the moment t₀ and the moment t₃.

Optionally, the second network node may obtain a first congestion degree J₁ based on the following formula:

$${J}_{1} = \frac{{v}_{1}}{{v}_{2}}$$

where v₁ is the first receiving rate of the first network node in the first time interval, and v₂ is the first sending rate of the second network node in the time interval between the second moment and the fourth moment.

For example, as shown in FIG. 8, v₁ may be the first receiving rate of the first network node in the time interval between the moment t₁ and the moment t₂; or a may be the first receiving rate of the first network node in the time interval between the moment t₂ and the moment t₄.

For example, as shown in FIG. 8, v₂ may be the first sending rate of the second network node in the time interval between the moment t₀ and the moment t₃.

Optionally, when the third moment and a start moment or an end moment of the first time interval do not overlap, the second network node further needs to perform step 381 to step 386. For example, as shown in FIG. 7, the first moment may be t₁, the second moment may be t₀, the third moment may be t₃, and the fourth moment may be t₄. When t₄ and an end moment of 2^{nd} tᵢ after the moment t₁ at which the first network node receives the first delimitation packet do not overlap, step 381 to step 386 further need to be performed.

Step 381: The second network node receives a second-type statistics packet sent by the first network node, where the second-type statistics packet includes the first identifier, and the second-type statistics packet is used to indicate a congestion status of the first network node in a time interval between the third moment and the start moment of the first time interval in which the third moment is located. Correspondingly, the first network node sends the second-type statistics packet to the second network node at the third moment.

Optionally, the second-type statistics packet includes a second receiving rate of the first network node in the time interval between the third moment and the start moment of the first time interval in which the third moment is located. Alternatively, the second-type statistics packet includes a fifth identifier, a sixth identifier, and the quantity of data packets that are received by the first network node, where statistics about the quantity of data packets are collected by the first network node, the fifth identifier is used to indicate the start moment of the first time interval in which the third moment is located, the sixth identifier is used to indicate the third moment, and the third moment is the moment at which the first network node receives the second delimitation packet.

Optionally, when sending the second-type statistics packet, the first network node records the sixth identifier and includes the sixth identifier in the second-type statistics packet. The first network node also includes the first identifier in the first delimitation packet and the fifth identifier recorded in the first network node together in the first-type statistics packet, and sends the first-type statistics packet to the second network node.

Optionally, the fifth identifier may be a fifth timestamp. The fifth timestamp is used to indicate the start moment of the first time interval in which third moment is located.

Optionally, the sixth identifier may be a sixth timestamp. The sixth timestamp is used to indicate the third moment.

For example, as shown in FIG. 7, the second network node sends the first delimitation packet at the moment t₀, and sends the second delimitation packet at the moment t₃. The time interval between the moment t₀ and the moment t₃ is the first time interval tᵢ. The first network node receives the first delimitation packet at the moment t₁, and receives the second delimitation packet at the moment t₄. The time interval between the moment t₁ and the moment t₄ is 1.8 times the first time interval. In other words, the moment t₄ and an end moment (a moment t₅) of a 2^{nd} first time interval do not overlap, and the first network node needs to send the second-type statistics packet to the second network node at the moment t₄. The second-type statistics packet includes the second receiving rate of the first network node in a time interval between a moment t₂ and the moment t₄; or the second-type statistics packet includes the moment t₀, the moment t₂, the moment t₄, and the quantity of data packets that are received by the first network node in the time interval between the moment t₂ and the moment t₄, where statistics about the quantity of data packets are collected by the first network node.

Step 382: The second network node obtains a second congestion degree based on the first data and the second-type statistics packet, where the second congestion degree is used to indicate a congestion degree in the time interval between the third moment and the start moment of the first time interval in which the third moment is located.

Optionally, after receiving the second-type statistics packet, the second network node may determine, based on the first identifier in the second-type statistics packet, that the second-type statistics packet sent by the first network node corresponds to the first data about which the second network node collects statistics. In other words, the second network node needs to obtain the second congestion degree based on the first data and the second-type statistics packet.

As shown in FIG. 7, the second congestion degree may be a congestion degree of a corresponding path in the time interval between the moment t₂ and the moment t₄.

Optionally, the second network node may obtain a second congestion degree J₂ based on the following formula:

$${J}_{2} = \frac{\frac{c}{Δ t}}{\frac{b}{{t}_{i}}}$$

where c is a quantity of data packets that are received by the first network node in the time interval between the third moment and the start moment of the first time interval in which the third moment is located, and Δt is the time interval between the third moment and the start moment of the first time interval in which the third moment is located.

For example, as shown in FIG. 7, c may be a quantity of data packets that are received by the first network node in the time interval between the moment t₂ and the moment t₄.

For example, as shown in FIG. 7, Δt may be the time interval between the moment t₂ and the moment t₄.

Optionally, the second network node may obtain a second congestion degree J₂ based on the following formula:

$${J}_{1} = \frac{{v}_{11}}{{v}_{2}}$$

where v₁₁ is the second receiving rate of the first network node in the time interval between the third moment and the start moment of the first time interval in which the third moment is located.

For example, as shown in FIG. 7, v₁₁ may be the second receiving rate of the first network node in the time interval between the moment t₂ and the moment t₄.

Step 383: The second network node receives a third-type statistics packet that is sent by the first network node at the end moment of the first time interval in which the third moment is located, where the third-type statistics packet includes the second identifier, and the third-type statistics packet is used to indicate the congestion status of the first network node in the time interval between the third moment and the end moment of the first time interval in which the third moment is located. Correspondingly, the first network node collects statistics about the congestion status in the time interval between the third moment and the end moment of the first time interval in which the third moment is located, and sends the third-type statistics packet to the second network node at the end moment of the first time interval in which the third moment is located.

Optionally, the third-type statistics packet includes a third receiving rate of the first network node in the time interval between the third moment and the end moment of the first time interval in which the third moment is located. Alternatively, the third-type statistics packet includes the sixth identifier, a seventh identifier, and the quantity of data packets that are received by the first network node, where statistics about the quantity of data packets are collected by the first network node, and the seventh identifier is used to indicate the end moment of the first time interval in which the third moment is located.

Optionally, when sending the third-type statistics packet, the first network node records the seventh identifier and includes the seventh identifier in the third-type statistics packet. The first network node also includes the first identifier in the first delimitation packet and the sixth identifier recorded in the first network node together in the third-type statistics packet, and sends the third-type statistics packet to the second network node.

Optionally, the seventh identifier may be a seventh timestamp. The seventh timestamp is used to indicate the end moment of the first time interval in which third moment is located.

For example, as shown in FIG. 7, the second network node sends the first delimitation packet at the moment t₀, and sends the second delimitation packet at the moment t₃. The time interval between the moment t₀ and the moment t₃ is the first time interval tᵢ. The first network node receives the first delimitation packet at the moment t₁, and receives the second delimitation packet at the moment t₄. The time interval between the moment t₁ and the moment t₄ is 1.8 times the first time interval. In other words, the moment t₄ and an end moment (a moment t₅) of a 2^{nd} first time interval do not overlap, and the first network node needs to send the third-type statistics packet to the second network node at the moment t₅. The third-type statistics packet includes the third receiving rate of the first network node in the time interval between the moment t₄ and the moment t₅; or the third-type statistics packet includes the moment t₃, the moment t₄, the moment t₅, and the quantity of data packets that are received by the first network node in the time interval between the moment t₄ and the moment t₅, where statistics about the quantity of data packets are collected by the first network node.

Step 384: The second network node collects statistics about second data, where the second data is used to indicate a congestion status in a time interval between the fourth moment and the fifth moment, the time interval between the fifth moment and the fourth moment is the first time interval, and the fifth moment is later than the fourth moment.

Optionally, the second data is a second sending rate in the time interval between the fourth moment and the fifth moment; or the second data is a quantity of data packets that are sent by the second network node in the time interval between the fourth moment and the fifth moment.

As shown in FIG. 7, the second data is a congestion status of the second network node in the first time interval tᵢ between the moment t₃ and a moment t₆. The second data may be a first sending rate of the second network node in the first time interval tᵢ between the moment t₃ and the moment t₆; or the first data may be a quantity of data packets that are sent by the second network node in the first time interval tᵢ between the moment t₃ and the moment t₆.

Step 385: The second network node obtains a third congestion degree based on the second data and the third-type statistics packet, where the third congestion degree is used to indicate a congestion degree in the time interval between the third moment and the end moment of the first time interval in which the third moment is located.

Optionally, after receiving the third-type statistics packet, the second network node may determine, based on the second identifier in the third-type statistics packet, that the third-type statistics packet sent by the first network node corresponds to the second data about which the second network node collects statistics. In other words, the second network node needs to obtain the third congestion degree based on the second data and the third-type statistics packet.

As shown in FIG. 7, the third congestion degree may be a congestion degree of a corresponding path in the time interval between the moment t₄ and the moment t₅.

Optionally, the second network node may obtain a third congestion degree J₃ based on the following formula:

$${J}_{3} = \frac{\frac{e}{( {t}_{i} - Δ t )}}{\frac{d}{{t}_{i}}}$$

where e is a quantity of data packets that are received by the first network node in the time interval between the third moment and the end moment of the first time interval in which the third moment is located, and d is the quantity of data packets that are sent by the second network node in the time interval between the fourth moment and the fifth moment.

For example, as shown in FIG. 7, e may be a quantity of data packets that are received by the first network node in the time interval between the moment t₄ and the moment t₅.

For example, as shown in FIG. 7, d may be a quantity of data packets that are sent by the second network node in the time interval between the moment t₃ and the moment t₆.

Optionally, the second network node may obtain a third congestion degree J₃ based on the following formula:

$${J}_{1} = \frac{{v}_{12}}{{v}_{21}}$$

where v₁₂ is a third receiving rate of the first network node in the time interval between the third moment and the end moment of the first time interval in which the third moment is located, and v₂₁ is a second sending rate of the second network node in the time interval between the fourth moment and the fifth moment.

For example, as shown in FIG. 7, v₁₂ may be the third receiving rate of the first network node in the time interval between the moment t₄ and the moment t₅.

For example, as shown in FIG. 7, v₂₁ may be the second sending rate of the second network node in the time interval between the moment t₃ and the moment t₆.

Step 386: The second network node obtains a fourth congestion degree based on the second congestion degree and the third congestion degree, where the fourth congestion degree is used to indicate a congestion degree in the first time interval in which the third moment is located.

Optionally, the second network node may determine an average value of the second congestion degree and the third congestion degree as the fourth congestion degree.

For example, as shown in FIG. 7, the second network node sends a delimitation packet to the first network node at the stipulated first time interval. In other words, the second network node sends the first delimitation packet at the moment t₀, and the first network node receives the first delimitation packet at the moment t₁. The second network node sends the second delimitation packet at the moment t₃, and the first network node receives the second delimitation packet at the moment t₄. The second network node sends a third delimitation packet at the moment t₆, and the first network node receives the third delimitation packet at a moment t₇. The second network node sends a fourth delimitation packet at a moment t₁₀, and the first network node receives the fourth delimitation packet at a moment t₁₁. A time interval between the moment t₀ and the moment t₃ is the first time interval tᵢ, a time interval between the moment t₃ and the moment t₆ is the first time interval tᵢ, and a time interval between the moment t₆ and the moment t₁₀ is the first time interval tᵢ. 1.8 first time intervals tᵢ are included between the moment t₁ and the moment t₄, and the second network node determines a final congestion degree between t₁ and t₂ based on a congestion degree between the moment t₁ and the moment t₂ and a congestion degree between the moment t₀ and the moment t₃. Because 1.8 is not a positive integer, the second network node determines a congestion status in the time interval between the moment t₂ and the moment t₅ in the following manner. First, the first network node needs to send a congestion status of the first network node in the time interval between the moment t₂ and the moment t₄ to the second network node at the moment t₄. The second network node determines a final congestion status in the time interval between the moment t₂ and the moment t₄ based on a congestion status between the moment t₂ and the moment t₄ and a congestion status of the first network node between the moment t₀ and the moment t₃. Second, the first network node needs to send the congestion status of the first network node in the time interval between the moment t₄ and the moment t₅ to the second network node at the moment t₅, and the second network node determines a final congestion status in the time interval between the moment t₄ and the moment t₅ based on a congestion status of the first network node in the time interval between the moment t₄ and the moment t₅ and a congestion status of the second network node between the moment t₃ and the moment t₆. Finally, the final congestion status in the time interval between the moment t₂ and the moment t₄ and the final congestion status in the time interval between the moment t₄ and the moment t₅ are determined as the congestion status in the time interval between the moment t₂ and the moment t₅. Therefore, congestion measurement accuracy is improved. In addition, the second network node may obtain a congestion status of a path between the first network node and the second network node at an equal time interval, to meet adjustment requirements on a data plane.

The method 300 may further include step 390.

Step 390: The second network node adjusts, based on the determined congestion degrees in the time intervals, traffic proportions shared on a plurality of paths in a tunnel between the first network node and the second network node.

It should be understood that sequence numbers of the foregoing processes do not mean an execution sequence in the embodiments of this application. The execution sequence of the processes should be determined based on functions and internal logic of the processes, and should not be construed as any limitation on the implementation processes of the embodiments of this application.

The congestion measurement method in the embodiments of this application is described in detail above with reference to FIG. 3 to FIG. 8. The apparatus in the embodiments of this application is described in detail below with reference to FIG. 9 to FIG. 12.

An embodiment of this application provides a network node. The following describes a structure and a function of the network node with reference to FIG. 9. FIG. 9 is a schematic block diagram of a network node 10 according to an embodiment of this application. As shown in FIG. 9, the network node 10 includes a receiver 11 and a transmitter 12. Optionally, the network node 10 further includes a processor 13 and a memory 14. The receiver 11, the transmitter 12, the processor 13, and the memory 14 communicate with each other through an inner connection path, to transfer a control signal and/or a data signal. The memory 14 is configured to store a computer program. The processor 13 is configured to invoke the computer program from the memory 14 and run the computer program, to control the receiver 11 to receive a signal, and control the transmitter 12 to send a signal. When the program stored in the memory 14 is executed by the processor 13, the receiver 11 is configured to receive a first delimitation packet, where the first delimitation packet includes a first identifier, and the first identifier is used to indicate a moment at which a second network node sends the first delimitation packet.

The processor 13 is configured to collect, based on the first delimitation packet, statistics about a congestion status of a first network node by using a first time interval as a periodicity, where the first time interval is a time interval at which the second network node sends two neighboring delimitation packets.

The transmitter 12 is configured to send a first-type statistics packet to the second network node by using the first time interval as a periodicity, where the first-type statistics packet includes the first identifier, and the first-type statistics packet is used to indicate the congestion status of the first network node in the first time interval.

The processor 13 and the memory 14 may be combined into a processing apparatus. The processor 13 is configured to execute program code stored in the memory 14, to implement the foregoing functions. In a specific implementation, the memory 14 may alternatively be integrated into the processor 13, or independent of the processor 13.

It should be understood that the network node 10 may correspond to the first network node in the congestion measurement method 300 in the network according to the embodiments of the present invention, and the network node 10 may include modules configured to perform the method performed by the first network node in the congestion measurement method 300 in the network in FIG. 3. In addition, the modules in the network node 10 and the foregoing other operations and/or functions are respectively intended to implement corresponding procedures of the congestion measurement method 300 in the network in FIG. 3. For a specific process of the foregoing corresponding steps performed by the units, refer to the foregoing description of the method embodiment in FIG. 3. For brevity, details are not described herein again.

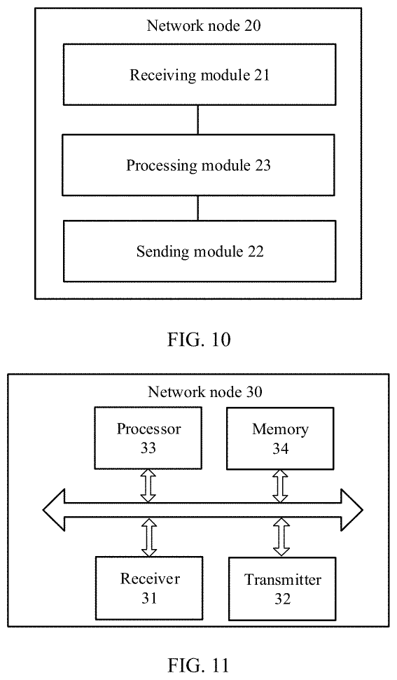

An embodiment of this application further provides a network node. The following describes a structure and a function of the network node with reference to FIG. 10. FIG. 10 is another schematic block diagram of a network node 20 according to an embodiment of this application. As shown in FIG. 10, the network node 20 includes a receiving module 21, a sending module 22, and a processing module 23.

The receiving module 21, the sending module 22, and the processing module 23 may be implemented by software or hardware. When the modules are implemented by hardware, the receiving module 21 may be the receiver 11 in FIG. 9, the sending module 22 may be the transmitter 12 in FIG. 9, and the processing module 23 may be the processor 13 in FIG. 9.

An embodiment of this application further provides another network node. The following describes a structure and a function of the network node with reference to FIG. 11. FIG. 11 is a schematic block diagram of a network node 30 according to an embodiment of this application. As shown in FIG. 11, the network node 30 includes a receiver 31 and a transmitter 32. Optionally, the network node 30 further includes a processor 33 and a memory 34. The receiver 31, the transmitter 32, the processor 33, and the memory 34 communicate with each other through an inner connection path, to transfer a control signal and/or a data signal. The memory 34 is configured to store a computer program. The processor 33 is configured to invoke the computer program from the memory 34 and run the computer program, to control the receiver 31 to receive a signal, and control the transmitter 32 to send a signal. When the program stored in the memory 34 is executed by the processor 33, the transmitter 32 is configured to send a first delimitation packet, where the first delimitation packet includes a first identifier, and the first identifier is used to indicate a moment at which a second network node sends the first delimitation packet.

The transmitter 32 is further configured to send a second delimitation packet, where the second delimitation packet includes a second identifier, and the second identifier is used to indicate a moment at which the second network node sends the second delimitation packet; the second delimitation packet and the first delimitation packet are two neighboring delimitation packets; and a time interval at which the second network node sends the two neighboring delimitation packets is a first time interval.

The processor 33 is configured to collect statistics about first data based on the first delimitation packet and the second delimitation packet, where the first data is used to indicate a congestion status in the first time interval.

The receiver 31 is configured to receive, by using the first time interval as a periodicity, a first-type statistics packet sent by a first network node, where the first-type statistics packet includes the first identifier, and the first-type statistics packet is used to indicate a congestion status of the first network node in the first time interval.

The processor 33 is further configured to obtain a first congestion degree based on the first data and the first-type statistics packet, where the first congestion degree is used to indicate a congestion degree in the first time interval.

The processor 33 and the memory 34 may be integrated into one processing apparatus. The processor 33 is configured to execute program code stored in the memory 34 to implement the foregoing functions. In a specific implementation, the memory 34 may alternatively be integrated into the processor 33, or independent of the processor 33.

It should be understood that the network node 30 may correspond to the second network node in the congestion measurement method 300 in the network according to the embodiments of the present invention, and the network node 30 may include modules configured to perform the method performed by the second network node in the congestion measurement method 300 in the network in FIG. 3. In addition, the modules in the network node 30 and the foregoing other operations and/or functions are respectively intended to implement corresponding procedures of the congestion measurement method 300 in the network in FIG. 3. For a specific process of the foregoing corresponding steps performed by the units, refer to the foregoing description of the method embodiment in FIG. 3. For brevity, details are not described herein again.

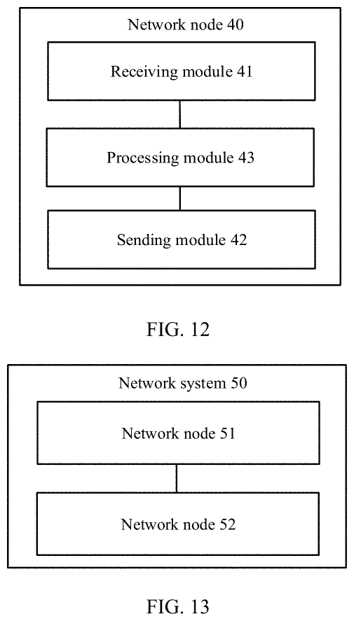

An embodiment of this application further provides a network node. The following describes a structure and a function of the network node with reference to FIG. 12. FIG. 12 is another schematic block diagram of a network node 40 according to an embodiment of this application. As shown in FIG. 12, the network node 40 includes a receiving module 41 and a sending module 42.

The receiving module 41 and the sending module 42 may be implemented by software or hardware. When the sending module 42 and the receiving module 41 are implemented by hardware, the receiving module 41 may be the receiver 31 in FIG. 11, and the sending module 42 may be the transmitter 32 in FIG. 11.

It should be understood that, the processor in the embodiments of this application may be a central processing unit (CPU), or may be another general-purpose processor, a digital signal processor (DSP), an application-specific integrated circuit (ASIC), a field programmable gate array (FPGA) or another programmable logic device, a discrete gate or a transistor logic device, a discrete hardware component, or the like. The general-purpose processor may be a microprocessor, or the processor may be any conventional processor or the like.

It may be understood that the memory in the embodiments of this application may be a volatile memory or a nonvolatile memory, or may include a volatile memory and a nonvolatile memory. The nonvolatile memory may be a read-only memory (ROM), a programmable read-only memory (PROM), an erasable programmable read-only memory (erasable PROM, EPROM), an electrically erasable programmable read-only memory (electrically EPROM, EEPROM), or a flash memory. The volatile memory may be a random access memory (RAM) that is used as an external buffer. Through an example rather than a limitative description, random access memories (RAMs) in many forms may be used, for example, a static random access memory (static RAM, SRAM), a dynamic random access memory (DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchlink dynamic random access memory (synchlink DRAM, SLDRAM), and a direct Rambus random access memory (direct Rambus RAM, DR RAM).

An embodiment of this application further provides a communication system. FIG. 13 is a schematic block diagram of a network device 50 according to an embodiment of this application. As shown in FIG. 13, the network system 50 includes a network node 51 and a network node 52. The network node 51 may be the network node 10 shown in FIG. 9, and the network node 52 may be the network node 30 shown in FIG. 11; or the network node 51 may be the network node 20 shown in FIG. 10, and the network node 52 may be the network node 40 shown in FIG. 12.

It should be understood that the network node 51 may correspond to the first network node in the congestion measurement method 300 in the network according to the embodiments of the present invention, and the network node 51 may include modules configured to perform the method performed by the first network node in the congestion measurement method 300 in the network in FIG. 3. The network node 52 may correspond to the second network node in the congestion measurement method 300 in the network according to the embodiments of the present invention, and the network node 52 may include modules configured to perform the method performed by the second network node in the congestion measurement method 300 in the network in FIG. 3. In addition, the modules in the network node 51 and the network node 52 and the foregoing other operations and/or functions are respectively intended to implement corresponding procedures of the congestion measurement method 300 in the network in FIG. 3. For a specific process of the foregoing corresponding steps performed by the units, refer to the foregoing description of the method embodiment in FIG. 3. For brevity, details are not described herein again.

In the network nodes in the foregoing embodiments, for example, the network node 51 and the network node 52, each network node is divided into a data plane and a control plane, where a connection is established between control planes of the network nodes. The control plane is mainly responsible for negotiating measurement capabilities and measurement parameters (for example, a time interval for collecting statistics about a congestion status). The data plane is mainly responsible for sending and receiving measurement packets, returning measurement results (for example, a statistics packet), and the like, and performing actual measurement to form a connection between data planes. For example, in the method 300, a data plane of the first network node is connected to a data plane of the second network node. When the data plane of the first network node is connected to the data plane of the second network node, the data plane of the second network node is mainly responsible for sending a measurement packet (for example, a first measurement packet) to the first network node. Correspondingly, the data plane of the first network node receives the measurement packet sent by the second network node. Alternatively, the data plane of the first network node sends a measurement result (for example, a first-type statistics packet) to the second network node. A control plane of the first network node is connected to a control plane of the second network node. When the control plane of the first network node is connected to the control plane of the second network node, the control plane of the second network node is mainly responsible for sending a setting packet to the first network node to negotiate measurement parameters between the first network node and the second network node.

All or some of the foregoing embodiments may be implemented by software, hardware, firmware, or any combination thereof. When software is used to implement the embodiments, all or some of the foregoing embodiments may be implemented in a form of a computer program product. The computer program product includes one or more computer instructions. When the computer program instructions are loaded or executed on the computer, the procedure or functions according to the embodiments of the present invention are all or partially generated. The computer may be a general-purpose computer, a dedicated computer, a computer network, or other programmable apparatuses. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, infrared, radio, or microwave) manner. The computer-readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a DVD), or a semiconductor medium. The semiconductor medium may be a solid-state drive.

It should be understood that, the term “and/or” in this specification describes only an association relationship for describing associated objects and represents that three relationships may exist. For example, A and/or B may represent the following three cases: Only A exists, both A and B exist, and only B exists. In addition, the character “/” in this specification usually indicates an “or” relationship between the associated objects.

A person of ordinary skill in the art may be aware that, in combination with the examples described in the embodiments disclosed in this specification, units and algorithm steps may be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the scope of this application.

It may be clearly understood by a person skilled in the art that, for the purpose of convenient and brief description, for a detailed working process of the foregoing system, apparatus, and unit, refer to a corresponding process in the foregoing method embodiments. Details are not described herein again.

In the several embodiments provided in this application, it should be understood that the disclosed system, apparatus, and method may be implemented in other manners. For example, the described apparatus embodiments are merely examples. For example, division into units is merely logical function division and may be other division during actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electrical, mechanical, or another form.

The units described as separate parts may or may not be physically separate, and parts displayed as units may or may not be physical units, may be located in one position, or may be distributed on a plurality of network units. Some or all of the units may be selected based on an actual requirement to achieve an objective of a solution of the embodiments.

In addition, functional units in the embodiments of this application may be integrated into one processing unit, or each of the units may exist alone physically, or two or more units may be integrated into one unit.

When the functions are implemented in a form of a software functional unit and sold or used as an independent product, the functions may be stored in a computer-readable storage medium. Based on such an understanding, the technical solutions of this application essentially, or the part contributing to the conventional technology, or some of the technical solutions may be implemented in a form of a software product. The computer software product is stored in a storage medium, and includes several instructions for instructing a computer device (which may be a personal computer, a server, a network device, or the like) to perform all or some of the steps of the methods described in the embodiments of this application. The foregoing storage medium includes any medium that can store program code, such as a USB flash drive, a removable hard disk, a read-only memory (ROM), a random access memory (RAM), a magnetic disk, or an optical disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims. The units described as separate parts may or may not be physically separate, and parts displayed as units may or may not be physical units, may be located in one position, or may be distributed on a plurality of network units. Some or all of the units may be selected based on an actual requirement to achieve an objective of a solution of the embodiments.

What is claimed is:

1. A method comprising:
receiving, by a first network node, a first delimitation packet, wherein the first delimitation packet comprises a first identifier indicating a time at which a second network node sends the first delimitation packet;
collecting, by the first network node, based on the first delimitation packet, statistics associated with a congestion status of the first network node by using a first time interval as a length of a cycle, wherein the second network node sends two neighboring delimitation packets during the first time interval; and
sending, by the first network node, a first-type statistics packet to the second network node by using the first time interval as the length of the cycle, wherein the first-type statistics packet comprises the first identifier, and the first-type statistics packet indicates the congestion status of the first network node in the first time interval.

2. The method according to claim 1, wherein the first-type statistics packet comprises a first receiving rate of the first network node in the first time interval.

3. The method according to claim 1, wherein the method further comprises:
receiving, by the first network node, a second delimitation packet at a third moment, wherein the second delimitation packet comprises a second identifier indicating a time at which the second network node sends the second delimitation packet, the second delimitation packet and the first delimitation packet are two neighboring delimitation packets, a time interval between the third moment and a first moment is greater than the first time interval, the first network node receives the first delimitation packet at the first moment, and wherein the first network device stops collecting the statistics associated with the congestion status of the first network node based on the second delimitation packet.

4. The method according to claim 3, wherein the third moment is comprised in the first time interval and does not overlap with a start moment or an end moment of the first time interval, and wherein the method further comprises:
after the first network device stops collecting the statistics, sending, by the first network device, a second-type statistics packet to the second network node at the third moment, wherein the second-type statistics packet comprises the first identifier, and the second-type statistics packet indicates a congestion status of the first network node in a time interval between the third moment and the start moment of the first time interval.

5. The method according to claim 4, wherein the second-type statistics packet comprises a second receiving rate of the first network node in the time interval between the third moment and the start moment of the first time interval.

6. The method according to claim 4, wherein the method further comprises:
collecting, by the first network device, statistics associated with a congestion status of the first network node in a time interval between the third moment and the end moment of the first time interval; and
sending a third-type statistics packet to the second network node at the end moment of the first time interval, wherein the third-type statistics packet comprises the second identifier, and the third-type statistics packet indicates the congestion status of the first network node in the time interval between the third moment and the end moment of the first time interval.

7. The method according to claim 6, wherein the third-type statistics packet comprises a third receiving rate of the first network node in the time interval between the third moment and the end moment of the first time interval.

8. The method according to claim 1, wherein the method further comprises:
receiving, by the first network node, a setting packet, wherein the setting packet indicates a time interval at which the first network node collects the statistics associated with the congestion status, and the setting packet comprises information indicating the first time interval; and
setting, as the first time interval based on the setting packet, the time interval at which the first network node collects the statistics associated with the congestion status.

9. A method comprising:
sending, by a second network node, a first delimitation packet, wherein the first delimitation packet comprises a first identifier indicating a time at which the second network node sends the first delimitation packet;
sending, by the second network node, a second delimitation packet, wherein the second delimitation packet comprises a second identifier indicating a time at which the second network node sends the second delimitation packet, the second delimitation packet and the first delimitation packet are two neighboring delimitation packets, and the second network node sends the two neighboring delimitation packets during a first time interval;
collecting, by the second network node, statistics associated with first data based on the first delimitation packet and the second delimitation packet, wherein the first data indicates a congestion status in the first time interval;
receiving, by the second network node and by using the first time interval as a length of a cycle, a first-type statistics packet sent by a first network node, wherein the first-type statistics packet comprises the first identifier, and the first-type statistics packet indicates a congestion status of the first network node in the first time interval; and
obtaining, by the second network node, a first congestion degree based on the first data and the first-type statistics packet, wherein the first congestion degree indicates a congestion degree in the first time interval.

10. The method according to claim 9, wherein the method further comprises:
receiving, by the second network node, a second-type statistics packet, wherein the second-type statistics packet comprises the first identifier, the second-type statistics packet indicates a congestion status of the first network node in a time interval between a third moment and a start moment of the first time interval, and the third moment is comprised in the first time interval and is a time at which the first network node receives the second delimitation packet; and
obtaining, by the second network node, a second congestion degree based on the first data and the second-type statistics packet, wherein the second congestion degree indicates a congestion degree in the time interval between the third moment and the start moment of the first time interval.

11. The method according to claim 10, wherein the method further comprises:
receiving, by the second network node, a third-type statistics packet, wherein the third-type statistics packet comprises the second identifier, and the third-type statistics packet indicates a congestion status of the first network node in a time interval between the third moment and an end moment of the first time interval;
collecting, by the second network node, statistics associated with second data, wherein the second data indicates a congestion status in the first time interval between a fourth moment and a fifth moment, the fourth moment is a time at which the second network node sends the second delimitation packet, a time interval between the fifth moment and the fourth moment is the first time interval, and the fifth moment is later than the fourth moment;
obtaining, by the second network node, a third congestion degree based on the second data and the third-type statistics packet, wherein the third congestion degree indicates a congestion degree in the time interval between the third moment and the end moment of the first time interval; and
obtaining, by the second network node, a fourth congestion degree based on the second congestion degree and the third congestion degree, wherein the fourth congestion degree indicates a congestion degree in the first time interval.

12. The method according to claim 9, wherein the method further comprises:
sending, by the second network node, a setting packet, wherein the setting packet indicates a time interval at which the first network node collects statistics associated with congestion status, and the setting packet comprises information indicating the first time interval.

13. A network node, comprising:
one or more processors; and
a non-transitory computer-readable memory storing a program to be executed by the one or more processors, the program including instructions that, when executed by the one or more processors, cause the network node to:
receive a first delimitation packet from a second network node, wherein the first delimitation packet comprises a first identifier indicating a time at which the second network node sends the first delimitation packet;
collect, based on the first delimitation packet, statistics associated with a congestion status of the network node by using a first time interval as a length of a cycle, wherein the second network node sends two neighboring delimitation packets during the first time interval; and
send a first-type statistics packet to the second network node by using the first time interval as the length of the cycle, wherein the first-type statistics packet comprises the first identifier, and the first-type statistics packet indicates the congestion status of the network node in the first time interval.

14. The network node according to claim 13, wherein the first-type statistics packet comprises a first receiving rate of the network node in the first time interval.

15. The network node according to claim 13, wherein the program further comprises instructions that, when executed by the one or more processors, cause the network node to:
receive a second delimitation packet at a third moment, wherein the second delimitation packet comprises a second identifier indicating a time at which the second network node sends the second delimitation packet, the second delimitation packet and the first delimitation packet are two neighboring delimitation packets, a time interval between the third moment and a first moment is greater than the first time interval, and the network node receives the first delimitation packet at the first moment; and wherein the network node
stops collecting the statistics associated with the congestion status of the network node based on the second delimitation packet.

16. The network node according to claim 15, wherein the third moment is comprised in the first time interval and does not overlap with a start moment or an end moment of the first time interval, and wherein the program further comprises instructions that, when executed by the one or more processors, cause the network node to send a second-type statistics packet to the second network node at the third moment, wherein the second-type statistics packet comprises the first identifier, and the second-type statistics packet indicates a congestion status of the network node in a time interval between the third moment and the start moment of the first time interval.

17. The network node according to claim 16, wherein the second-type statistics packet comprises a second receiving rate of the network node in the time interval between the third moment and the start moment of the first time interval.

18. The network node according to claim 16, wherein the program further comprises instructions that, when executed by the one or more processors, cause the network node to:
collect statistics associated with a congestion status of the network node in a time interval between the third moment and the end moment of the first time interval; and
send a third-type statistics packet to the second network node at the end moment of the first time interval in which the third moment is located, wherein the third-type statistics packet comprises the second identifier, and the third-type statistics packet indicates the congestion status of the network node in the time interval between the third moment and the end moment of the first time interval.

19. The network node according to claim 18, wherein the third-type statistics packet comprises a third receiving rate of the network node in the time interval between the third moment and the end moment of the first time interval.

20. The network node according to claim 13, wherein the program further comprises instructions that, when executed by the one or more processors, cause the network node to:
receive a setting packet, wherein the setting packet indicates a time interval at which the network node collects the statistics associated with the congestion status, and the setting packet comprises information indicating the first time interval; and
set, as the first time interval based on the setting packet, the time interval at which the network node collects the statistics associated with the congestion status.
